(19) United States
(12) Patent Application Publication
(10) Pub. No.: US 2021/0178559 A1
(43) Pub. Date: Jun. 17, 2021

(54) TORQUE WRENCH

(71) Applicant: TORQUE TECHNOLOGIES LTD., Limerick (IE)

(72) Inventors: Dara Ryan, County Limerick (IE); Robert Benn, County Limerick (IE); James O'Regan, County Limerick (IE)

(21) Appl. No.: 16/758,706

(22) PCT Filed: Oct. 19, 2018
(86) PCT No.: PCT/EP2018/078735

§ 371 Date: Apr. 23, 2020

(30) Foreign Application Priority Data
Oct. 27, 2017 (IE) S2017/0229

(51) Int. Cl. B25B 23/142; B25B 23/00; B25B 23/14; B25G 1/06

(52) U.S. Cl. CPC B25B 23/1425; B25B 23/0028; B25G 1/043; B25B 23/1415; B25G 1/063; B25B 23/1427

(57) ABSTRACT

A torque wrench comprising a head portion having a socket drive for engaging a fastener to be tightened via a suitable socket and a handle portion having a grip for applying force to the drive via a releasable holding mechanism, wherein the releasable holding mechanism is adapted to allow the head portion to pivot with respect to the handle portion when the torque wrench is used to applied to predetermined torque to the socket drive, wherein the torque wrench further comprises at least one electronic sensor for measuring the torque applied to the socket drive and display means for displaying the measured torque.

### FIELD OF THE INVENTION

This invention relates to a torque wrench and in particular to an improved breaking torque wrench incorporating data capture functionality during use to provide improved traceability and proof of compliance in relation to the use of the torque wrench.

### BACKGROUND OF THE INVENTION

Mechanical torque wrenches have been in use for over a century, and are well known and trusted in most industries. In a mechanical torque wrench a standard mechanical click occurs when a preset torque is reached. The risk of over-torqueing is mitigated through 2-6° of free angular movement of the head of the torque wrench once the pre-set “click-out” point has been reached. During this free angular rotation, no additional torque beyond the preset torque is applied to the fastener or workpiece, thereby affording the operator a window where the force being applied to the grip of the torque wrench can be released without the risk of over-torque.

A mechanical breaking wrench further improves on this by incorporating a free angular rotation of 15-25° between the two sections of the torque wrench once a preset torque has been reached. In increasing this permissible free angular rotation, the operator is given a greater window of opportunity to release the torque without the risk of over-torque. This also allows the operator to use the wrench at a much greater speed as the risk of torqueing through the free angular rotation is reduced in comparison to a traditional mechanical click wrench where the handle of the wrench pivots through a limited angle with respect to the head.

The robustness, speed of operation and a reduced risk of over-torque are the primary benefits of a mechanical torque wrench, in so far as these features promote process efficiency, and productivity. However, the lack of data collection in relation to the use of a traditional mechanical torque wrench is a particular problem where proof of compliance in the use of the torque wrench is required, leading many companies to electronic torque wrenches.

Electronic torque wrenches are becoming increasingly common in production, assembly and maintenance environments due to increased regulation in an increasingly litigious society. In electronic torque wrenches an electronic sensor, typically a strain gauge, is used to measure the torque applied to a fastener by the wrench, rather than relying on a mechanical device to determine when a predetermined torque has been reached. The inherent accuracy and facility for electronic data capture of an electronic torque wrench help to address these concerns.

However, there are several disadvantages associated with electronic torque wrenches. Firstly the application of torque is much slower with manual electronic torque wrenches compared with mechanical torque wrenches, because there is no distinct tactile indicator that a desired torque has been reached. Instead, the operator relies upon visual and audible alarms that indicate when the pre-programmed parameters have been reached. In certain cases, vibrating sensors can be utilised to provide haptic feedback, but this method is not suitable for all situations, especially those where the operator uses gloves. Furthermore, this method of haptic feedback does not sufficiently mitigate the risk of the operator over-torqueing, thereby introducing concerns surrounding the potential negative effects over-torqueing has on the integrity of a joint, fastener workpiece or wrench transducer.

### SUMMARY OF THE INVENTION

According to the present invention there is provided a torque wrench comprising a head portion having a socket drive for engaging a fastener to be tightened via a suitable socket and a handle portion having a grip for applying force to the drive via a releasable holding mechanism, wherein the releasable holding mechanism is adapted to allow the handle portion to pivot with respect to the head portion when the torque wrench is used to apply a predetermined torque to the fastener, wherein the torque wrench further comprises at least one electronic sensor for measuring the torque applied to the socket drive and display means for displaying the measured torque or validating the torque result.

In a preferred embodiment the torque wrench further comprises an electronic control unit incorporating means for recording data received from said at least one electronic sensor, such as maximum torque applied by the torque wrench during each use. Said electronic control unit may incorporate a counter for recording the number of times the torque wrench is used. Preferably said electronic control unit is programmed to provide an alert when the torque wrench has been used a predetermined number of times for indicating when re-calibration of the wrench is required.

The electronic control unit may include wired and/or wireless transmission means for transmitting data to a remote location.

The electronic display may be incorporated into a user-interface unit, wherein the electronic control unit can be programmed through the user-interface unit, and/or by means of another device via a wireless or wired connection.

In a particularly preferred embodiment the torque wrench is of the breaking wrench type wherein said releasable holding mechanism comprises a breaking mechanism including an adjustable spring located in the handle section acting against a releasable holding device to determine how much force can be applied to the grip, and thereby transferred between the handle section and head section of the torque wrench before the holding device of the breaking mechanism is released, allowing the handle section to pivot about the pivot joint with respect to the head section. The breaking mechanism may be provided on the handle section and said at least one electronic sensor and display means, and preferably other electronic components of the wrench, may be provided on the head section. The head section may be separable from the handle section.

In a preferred embodiment data recorded by the electronic control unit is associated with additional information to enable a full record of the usage of the torque wrench to be provided.

The dimensions of the grip may be adapted to correspond to the size of the average male hand to constrain the positioning of the users hand on the handle portion, mitigating the effect of hand placement on the accuracy and precision of the torque wrench, in use.

According to a second aspect of the invention, there is provided an interchangeable smart-sensor for a torque wrench, the interchangeable smart sensor comprising a socket drive for engaging a fastener to be tightened via a suitable socket and an electronic sensor which comprises means for storing data in relation to at least one or more of the electronic sensor serial number, a live count of torque applications, a date of calibration and calibration coefficients, the smart-sensor further comprising a connection means for operable connection to a torque wrench.

### BRIEF DESCRIPTION OF THE DRAWINGS

A hybrid torque wrench in accordance with an embodiment of the present invention will now be described, by way of example only, with reference to the accompanying drawings, in which:

FIG. 1 is a perspective view of a hybrid torque wrench in accordance with an embodiment of the present invention;

FIG. 2 is a perspective view of the torque wrench of FIG. 1 with the breaking mechanism in a released configuration following the application of a predetermined torque;

FIG. 3 is a perspective view of the torque wrench of FIG. 1 with the head portion and handle portion separated from each other;

FIG. 4 is a plan view of the torque wrench of FIG. 1 from above; and

FIG. 5 is a side view of a smart sensor for a torque wrench.

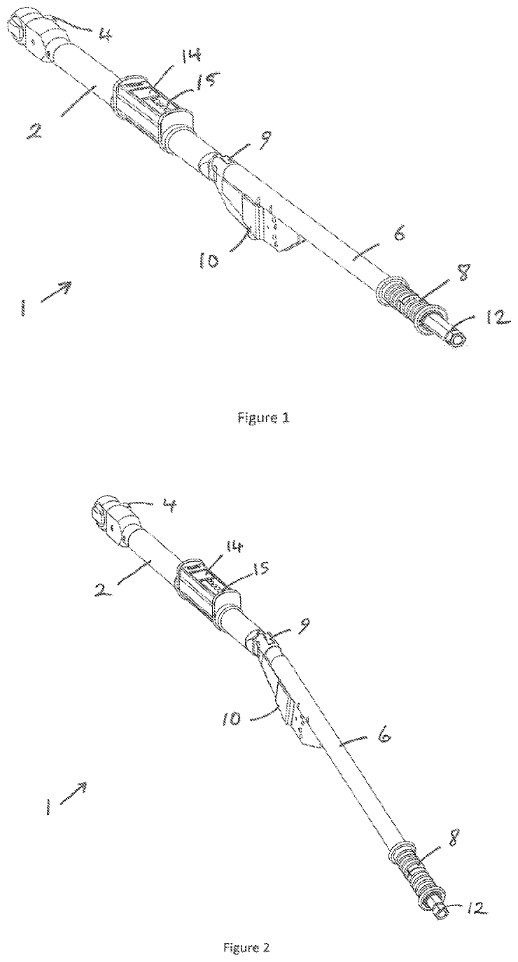

### DETAILED DESCRIPTION OF THE DRAWINGS

In order to address the disadvantages of known electronic and mechanical torque wrenches, the hybrid wrench in accordance with the present invention incorporates the best features of both concepts of torque wrenches, and in doing so mitigates the traditional concerns associated with them.

In the embodiment shown in the drawings, a hybrid torque wrench 1 in accordance with the present invention comprises the breaking wrench type, comprising a head section 2 having a socket drive 4 adapted to drivingly engage a socket of a selected size required to fit a fastener to be tightened, and a handle section 6 having a grip 8 at a distal end to be held by the operator during tightening of the fastener, the head and handle sections 2,6 being pivotally coupled to one another at a pivot joint 9, a breaking mechanism 10 being associated with pivot joint 9 adapted to release at a selected torque, allowing relative pivotal movement between the head and handle sections 2,6 of the torque wrench 1 about the pivot joint 9 once the selected torque has been reached.

The breaking mechanism 10 of the hybrid torque wrench 1, as known in the prior art, uses an adjustable spring located in the handle section acting against a releasable holding device to determine how much force (which is proportional to the torque at the socket drive 4) can be applied to the grip 8, and thereby transferred between the handle section 6 and head section 2 of the torque wrench 1 before the holding device of the breaking mechanism 10 is released, allowing the head section 2 to pivot about the pivot joint 9 with respect to the handle section 6.

This release of the holding device of the breaking mechanism 10 and resulting pivotal motion between the head and handle sections 2,6 of the torque wrench 1 gives the operator feedback that the desired torque has been reached while giving adequate opportunity to release the force applied to the grip, and therefore mitigates the risk of over-torqueing a fastener.

An adjustment mechanism 12 is provided at a distal end of the handle section 6 of the torque wrench 1 for setting the torque to be applied before the breaking mechanism 10 releases. The adjustment mechanism may be adapted to adjust the compression of the spring acting against the holding device of the breaking mechanism 10.

To overcome the lack of data capture with known mechanical torque wrenches, in the hybrid torque wrench in accordance with the present invention, one or more electronic sensors may be provided for measuring the torque applied to a fastener by the torque wrench, as described below in more detail. The one or more electronic sensors, such as strain gauges, may be associated with the socket drive 4 in the head portion 2 of the torque wrench 1. An electronic display 14 may be provided for displaying the applied torque and other data. Preferably an electronic control module is provided for recording data concerning the use of the torque wrench 1, such as the maximum torque applied to a fastener during use and/or the number of times that the torque wrench is used. The electronic display 16 may be incorporated into a user interface unit 15. The user-interface unit 15 may have a multitude of different functions, primary among which is the display of torque and angle parameters, live measurements and results. The electronic control unit can be programmed through the user-interface unit 15 or by means of another device via any wireless or wired connection systems.

The data recorded by the electronic control unit may be associated with time and date information so that a full record of the usage of the torque wrench can be provided.

Wired or wireless transmission means may be provided for transferring data from the electronic control unit to a remote location or source such as a computer, programmable logic controller, tablet, server, etc. The advantages of capturing the final installed torque of fasteners upon which the torque wrench is used are manifold, with users benefitting in terms of financial savings, process improvements, reduced risk of litigation & increased productivity.

In all known mechanical torque wrenches, and the majority of electronic torque wrenches, there is a difficulty in determining when the torque wrench should be calibrated. In accordance with ISO & ASME standards, it is currently recommended that a torque wrench should be calibrated every year or every 5,000 cycles, whichever may come first. In situations where a torque wrench is not used frequently, the torque wrench can be calibrated every year and therefore ensure compliance to the relevant ISO & ASME standards. However, the hybrid torque wrench in accordance with the present invention is primarily designed for situations where an operator may use a torque wrench tens or even several hundred times a day. In situations such as these, it is of primary importance to be aware of when a torque wrench may require calibration.

To solve this problem the electronic control unit of the hybrid torque wrench in accordance with an embodiment of the present invention may incorporate a counter, whereby every time a torque is applied with the hybrid torque wrench, the electronic control unit logs this application of torque and adds it to the number of cycles since its last calibration. Once the torque counter approaches the ISO & ASME recommended number of cycles, the operator may be notified that a requirement for calibration is imminent, before further notification when the ISO & ASME recommended number of cycles has been reached. The operator may be notified through the electronic display 14 and the electronic torque measurement feature of the torque wrench may cease to work until a calibration has been carried out.

In the embodiment shown the sensors, electronic display and electronic control unit and other electronic components may be housed in the head section 2 of the torque wrench while the breaking mechanism 10 is mounted on the handle section 6.

The positioning of the electronic sensors and control electronics on the head section 2 of the torque wrench may ensure that the torque and angle measurement accuracy of the torque wrench will not be negatively impacted by the free angular rotation of handle section 6 upon release of the breaking mechanism 10.

Batteries may be mounted within the head section 2, more preferably within the housing of the user-interface unit, for powering the electronic components of the torque wrench 1.

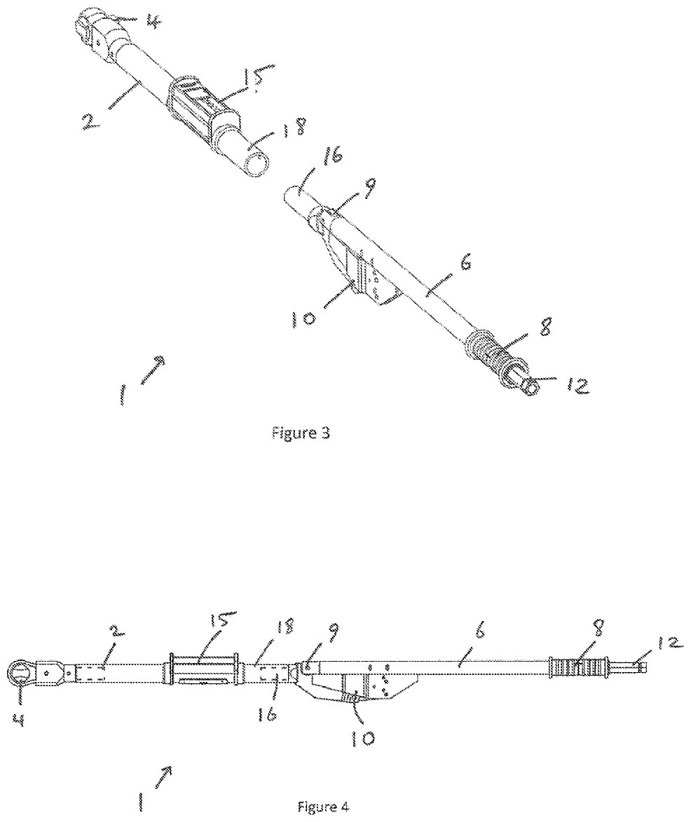

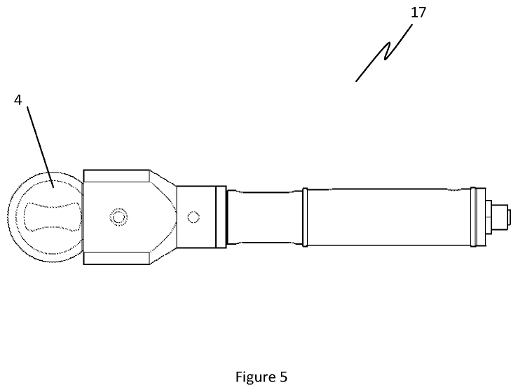

In the embodiment shown in FIGS. 3 and 4, the head section 2 of the torque wrench 1 may be connected to the handle section 6 by inserting a spigot 16 extending from the pivot joint 9 into a tubular body 18 of the head section 2 and securing the spigot 16 therein through a mechanical fastening. This facilitates quick and easy assembly and disassembly. The weight and size of the full length torque wrench 1 may be such that it can be costly, in terms of both time and money, to transport the full torque wrench to a certified calibration laboratory for calibration or repair. Furthermore, the inventor also recognises that this tool will be used in a fast-moving, production or maintenance environment where process efficiency and the minimisation of potential tool downtime is a priority. When a calibration or part replacement is required, the head section 2 or handle section 6 (incorporating the mechanical breaking mechanism 10) can be disassembled from one another and shipped separately, thereby reducing shipping costs. Furthermore, the two distinctive parts of the torque wrench are mutually exclusive from one another and are compatible with other versions of the same attachments. This results in the operator being able to hold spare parts of each of the two parts, thereby reducing the potential tool downtime and increasing process efficiency and productivity.

The force that is applied to the grip 8 of the torque wrench 1 is directly proportional to the torque that is applied by the socket drive 4 to the fastener. In prior art, the grip 8 of the wrench is typically large enough that the operators hand/hands can be placed in a range of different positions. As a result of this, the torque applied at the socket drive 4 can differ significantly depending where the operator was to place their hand on the grip 8 (as Torque=Force×Distance from point of rotation). The inventor appreciates that this is a known issue with existing mechanical breaking wrenches, yet as torque is not captured this potential discrepancy is often overlooked. In order to achieve the accuracy expected of an electronic torque wrench, the grip 8 will be reduced in length to the size of an above average male hand. This mitigates the effect that hand placement has on the accuracy and precision of the wrench.

In one embodiment of the invention, the socket drive 4 and electronic sensor are incorporated into an interchangeable smart-sensor 17. This interchangeable smart-sensor 17 comprises the socket drive 4, the electronic sensor, an electronic sensor PCB, and a connector. The electronic sensor PCB stores the electronic sensor serial number, a live count of torque applications, the date of calibration and the calibration coefficients. This enables the quick interchanging of smart-sensors 17 without the need to remove the user-interface unit 15 which therefore can reduce downtime relating to re-calibration, and also reduce shipping costs due to the smaller size and weight.

In consolidating features such as data capture of both torque and angle, speed of use, modularity and a mitigated risk of over-torque, a hybrid torque wrench 1 in accordance with the present invention can increase productivity, traceability and compliance of an individual or company to a point that will better satisfy modern day requirements.

The invention is not limited to the embodiments described herein but can be amended or modified without departing from the scope of the present invention.

1. A torque wrench comprising a head portion having a socket drive for engaging a fastener to be tightened via a suitable socket and a handle portion having a grip for applying force to the drive via a releasable holding mechanism, wherein the releasable holding mechanism is adapted to allow the handle portion to pivot with respect to the head portion when the torque wrench is used to apply a predetermined torque to the socket drive, wherein the torque wrench further comprises at least one electronic sensor for measuring the torque applied to the fastener and display means for displaying the measured torque or validating the torque result.

2. A torque wrench as claimed in claim 1, further comprising an electronic control unit incorporating means for recording data received from said at least one electronic sensor, such as maximum torque applied by the torque wrench during each use.

3. A torque wrench as claimed in claim 2, wherein said electronic control unit incorporates a counter for recording the number of times the torque wrench is used.

4. A torque wrench as claimed in claim 3, wherein said electronic control unit is programmed to provide an alert when the torque wrench has been used a predetermined number of times for indicating when re-calibration of the wrench is required.

5. A torque wrench as claimed in claim 2, wherein said electronic control unit includes wired and/or wireless transmission means for transmitting data to a remote location.

6. A torque wrench as claimed in claim 2, wherein the electronic display is incorporated into a user-interface unit, wherein the electronic control unit can be programmed through the user-interface unit and/or by means of another device via a wireless or wired connection.

7. A torque wrench as claimed in claim 1, breaking wrench type wherein said releasable holding mechanism comprises a breaking mechanism including an adjustable spring located in the handle section acting against a releasable holding device to determine how much force can be applied to the grip, and thereby transferred between the handle section and head section of the torque wrench before the holding device of the breaking mechanism is released, allowing the head section to pivot about the pivot joint with respect to the handle section.

8. A torque wrench as claimed in claim 7, wherein said breaking mechanism is provided on the handle section and said at least one electronic sensor and display means are provided on the head section.

9. A torque wrench as claimed in claim 8, wherein the head section is separable from the handle section.

10. A torque wrench as claimed in claim 1, wherein data recorded by the electronic control unit is associated with additional information to enable a full record of the usage of the torque wrench to be provided.

11. A torque wrench as claimed in claim 1, wherein the dimensions of the grip are adapted to correspond to the size of the average male hand to constrain the positioning of the users hand on the handle portion, mitigating the effect of hand placement on the accuracy and precision of the torque wrench, in use.

12. An interchangeable smart-sensor for a torque wrench, the interchangeable smart sensor comprising a socket drive for engaging a fastener to be tightened via a suitable socket and an electronic sensor which comprises means for storing data in relation to at least one or more of the electronic sensor serial number, a live count of torque applications, a date of calibration and calibration coefficients, the smart-sensor further comprising a connection means for operable connection to a torque wrench.
